(19) United States
(12) Patent Application Publication
(10) Pub. No.: US 2017/0124566 A1
(43) Pub. Date: May 4, 2017

(54) PIN-BASED PAYMENT CONFIRMATION

(71) Applicant: PayPal, Inc., San Jose, CA (US)

(72) Inventors: Victor Manuel Thornton, LaVista, NE (US); Jack Lindell, Omaha, NE (US); Chris Ortner, Omaha, NE (US); Scott Lewis, Omaha, NE (US)

(21) Appl. No.: 15/402,285

(22) Filed: Jan. 10, 2017

Related U.S. Application Data
(63) Continuation of application No. 13/032,741, filed on Feb. 23, 2011.

(51) Int. Cl. G06Q 20/40; G06Q 20/32; G06Q 20/10; G06Q 30/06

(52) U.S. Cl. CPC G06Q 20/4012; G06Q 30/0641; G06Q 20/4016; G06Q 20/3226; G06Q 20/102; G06Q 30/0613

(57) ABSTRACT

The present disclosure involves a method of operating a payment platform. The method includes receiving a request to authenticate a first party from a second party. The method includes determining whether the first party has an account with the payment platform and a communications device associated with the account. The method includes generating a secret code in response to the determining. The method includes sending the secret code to the communications device of the first party. The method includes prompting the first party to input the secret code. The method includes authenticating the first party based on the input from the first party.

### CLAIM OF PRIORITY

This application is a continuation of U.S. patent application Ser. No. 13/032,741, filed on Feb. 23, 2011, entitled “Pin-Based Payment Confirmation”, the disclosure of which is hereby incorporated by reference in its entirety.

### BACKGROUND

Technical Field

The present invention generally relates to facilitating electronic commerce over a network and, more particularly, to reducing fraud risks for online purchasing transactions.

Related Art

Online transaction are becoming more and more prevalent, with an ever-increasing number of online merchants and online payment mechanisms. The increase is due partly to the ease and convenience of making a purchase online instead of physically at a store. Unfortunately, the popularity of online transactions has also led to an increase in online fraud. activities. For example, a person may illegally obtain access to a victim's online account(s), and may attempt to purchase goods from the victim's account(s). To combat online fraud, various forms of fraud-reduction mechanisms have been implemented, but they may still suffer from shortcomings such as lengthy delays, confusing user interaction, and/or reliance on complicated algorithms.

Therefore, while existing online fraud-reduction mechanisms have been generally adequate for their intended purposes, they have not been entirely satisfactory in every aspect. It would be advantageous to offer an online fraud-reduction mechanism that is quick, intuitive, and simple.

### SUMMARY

One of the broader forms of the present disclosure involves a method of operating a payment platform. The method includes: receiving a request to authenticate a first party from a second party; determining whether the first party has an account with the online payment platform and a communications device associated with the account; generating a secret code in response to the determining; sending the secret code to the communications device of the first party; prompting the first party to input the secret code; and thereafter authenticating the first party based on the input from the first party.

Another one of the broader forms of the present disclosure involves an apparatus comprising a non-transitory, tangible computer readable storage medium storing a computer program. The computer program has instructions that when executed, carry out: receiving a request to authenticate a first party from a second party; determining whether the first party has an account with the online payment platform and a communications device associated with the account; generating a secret code in response to the determining; sending the secret code to the communications device of the first party; prompting the first party to input the secret code; and thereafter authenticating the first party based on the input from the first party.

Yet another one of the broader forms of the present disclosure involves an electronic payment processing system. The electronic payment processing system includes: means for receiving an authentication request sent by a seller that is engaged in a prospective purchasing transaction with a buyer; means for verifying whether the buyer has an account associated with the electronic payment processing system and a communications device linked to the account; means for dynamically and randomly generating a secret code based on results of the verifying; means for delivering the secret code to the communications device of the buyer; means for prompting the buyer to enter the secret code; and means for authenticating the buyer based on whether the buyer has correctly entered the secret code within a predetermined number of attempts.

### BRIEF DESCRIPTION OF THE DRAWINGS

FIGS. 1-2 show different stages of an example online merchant's user interface.

FIGS. 3-7 show different stages of an example third party payment platform's user interface that is superimposed over the online merchant's user interface.

FIG. 8 shows an flowchart illustrating the various process flows according to various aspects of the present disclosure.

FIG. 9 shows a block diagram of a computer system for implementing various methods and devices described according to various aspects of the present disclosure,

### DETAILED DESCRIPTION

It is to be understood that the following disclosure provides many different embodiments, or examples, for implementing different features of the invention. Specific examples of components and arrangements are described below to simplify the present disclosure. These are, of course, merely examples and are not intended to be limiting. Various features may be arbitrarily drawn in different scales for simplicity and clarity.

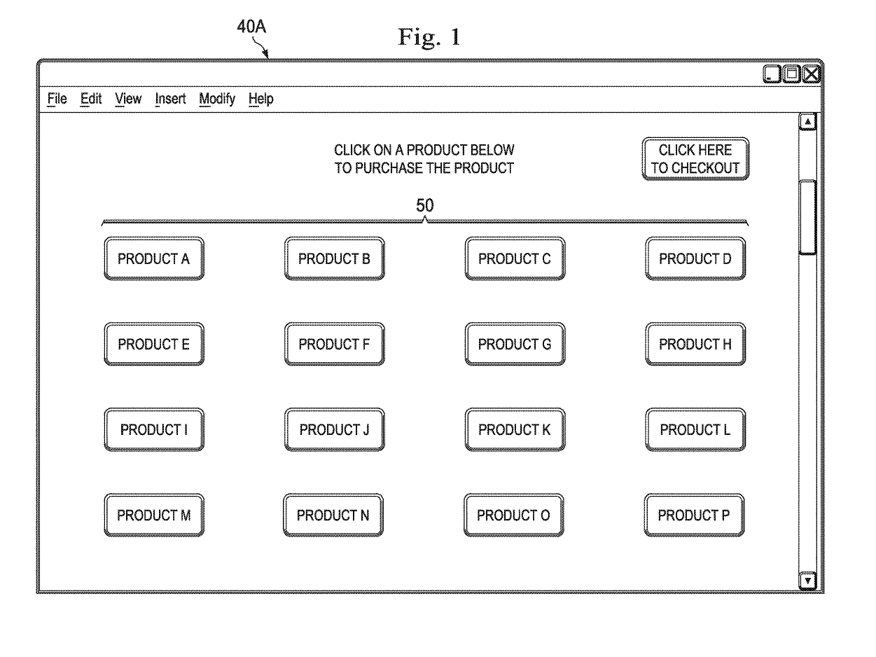

FIG. 1 illustrates an example user interface 40A from a merchant. The merchant is engaged in selling of products (goods), where product or good is used herein to include physical goods, digital goods, services, charitable donations, etc. In an embodiment, the merchant is an online merchant that sells products through a website, and the user interface 40A is in the form of a web page. The user interface 40A is in a product-selection phase and displays a plurality of objects 50 that each represent a different product. The objects 50 may each contain a button, an icon, a picture, or combinations thereof.

The products represented by the objects 50 may include physical and tangible goods, including (but not limited to) clothing, electronics, tools, toys, household appliances, books, movies, automotive components, sporting goods, groceries, etc. The products represented by the objects 50 may also include digital goods, which include goods that are stored, delivered, and/or used in an electronic format. As non-limiting examples, digital goods may include electronic-books, digital music files, digital images, digital videos, virtual items, etc. The virtual items may be virtual currency (e.g., virtual gold) or other types of precious items (e.g., virtual weapons/armor, virtual medicine, virtual gems) that can be obtained and used in a. virtual reality role-playing computer game, for instance. Similar to physical and tangible goods, digital goods can be bought and sold between interested parties. The buyer of a digital good may receive the purchased digital good through an email attachment, a download, or other suitable mechanisms.

As is illustrated in FIG. 1, the user interface 40A informs a prospective buyer what products are available from the merchant. To initiate the purchasing process, the prospective buyer may click on any one of the objects 50 to add it to the buyer's purchasing queue, which may be in the form of a virtual shopping cart. The prospective buyer may edit the purchasing queue at any time, such as adding or subtracting the quantity of a particular product in the queue or removing a product from the queue altogether. For the sake of simplicity, the details of the purchasing queue are not illustrated herein.

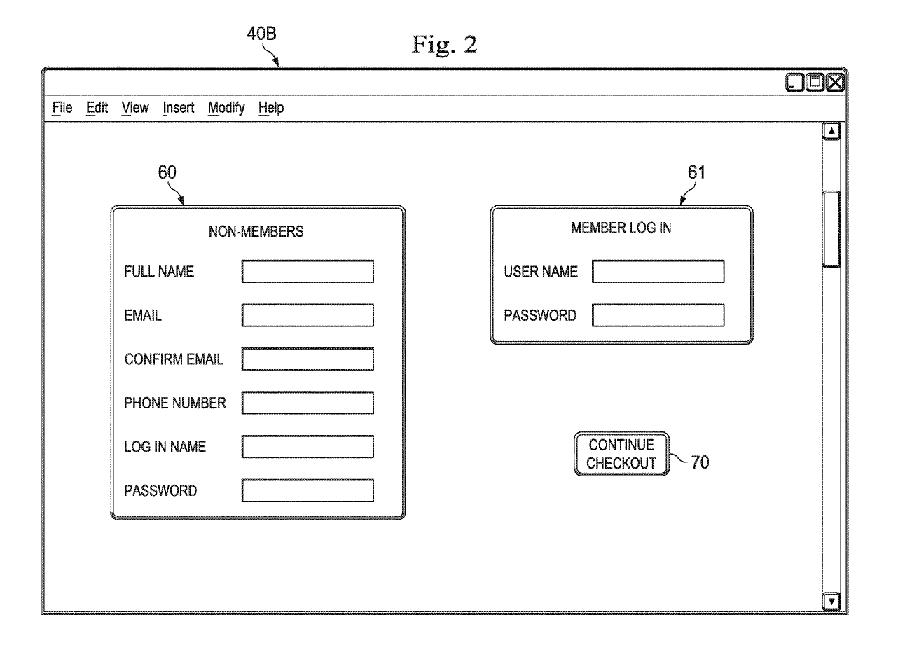

FIG. 2 illustrates an example of a user interface 40B in a check-out phase of the transaction. In the check-out phase, the prospective buyer has tentatively decided on what goods he would like to purchase from the merchant and is trying to complete the transaction. The user interface 40B contains two sections 60 and 61 in the embodiment shown in FIG. 2. The section 60 is reserved for non-members of the merchant's website. Therefore, the non-members may need to register with the website by supplying personal information such as full name, email address, phone number, intended user name (login name) and password. For regular (returning) members of the website, they only need to provide the user name and the password before proceeding to check out. The prospective buyer may click on a “continue checkout” button 70 to initiate the next step in the checkout process.

The merchant may be willing to accept payment from any one of several third party payment platforms for the transaction. A third party payment platform may be a bank, a credit card company, or any other suitable financial institution that has accounts with its users, and that is capable of transferring the funds from these users' accounts to another party like the merchant in this example. The merchant may list acceptable third party payment platforms on its user interface 40A/B, and may let the prospective buyer choose which third party payment platform to use to complete the transaction. For the sake of simplicity, the details of displaying and selecting the various third party payment platforms are not illustrated herein.

Once the prospective buyer chooses his preferred third party payment platform and clicks on the “continue checkout” button, an electronic message is sent to the merchant indicating that the prospective buyer would like to complete the transaction, as well as what third party payment platform to use for that transaction. In response, the merchant sends an authentication request to the designated third party payment platform, asking the third party payment platform to verify the prospective buyer's identity.

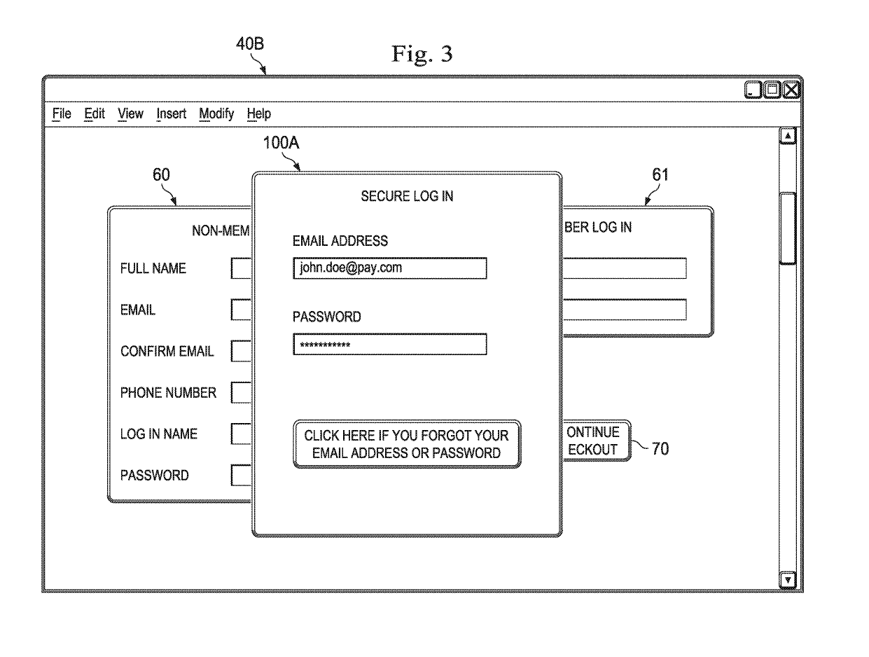

Referring now to FIG. 3, it illustrates an example user interface 100A generated by a third party payment platform in response to the merchant's authentication request. In an embodiment, the user interface 100A is in the form of a lightbox, which is a Javascript application used to display content. The lightbox may be superimposed over the merchant's user interface 40B, so that the lightbox is at the forefront of the prospective buyer's view. In other embodiments, the user interface 100A may take on other forms, for example as other pop-up windows/boxes, or as its own web page. The user interface 100A will prompt the prospective buyer to enter an email address (or a username) and a password to log in to the third party payment platform's system.

If the prospective buyer fails to supply a valid combination of email address and password, the third party payment system may direct the prospective buyer to an account validation flow (e.g., password recovery). It is assumed that the prospective buyer has forgotten either his email address or his password, or both. Thus the prospective buyer may be directed to a screen where he is prompted to answer one or more secret or security questions such as “what is your favorite TV show?”, “what was your mother's maiden name?”, “what was your high school team's mascot?”, etc. The answers to these secret questions have been supplied by the true account owner. In one embodiment, the true account owner knows these answers “by heart,” and these answers are not stored in a computer file that can be accessed by the account owner for additional security. In some cases, an account holder may store answers locally on the account holder's device, such as on a device memory or hard drive. If the prospective buyer answers these questions successfully, the third party payment system may validate the prospective buyer as a valid user and grant him access. Otherwise the third party payment system may terminate the transaction and notify the merchant as such. For the sake of simplicity, the user screen display associated with this account validation flow is not illustrated herein.

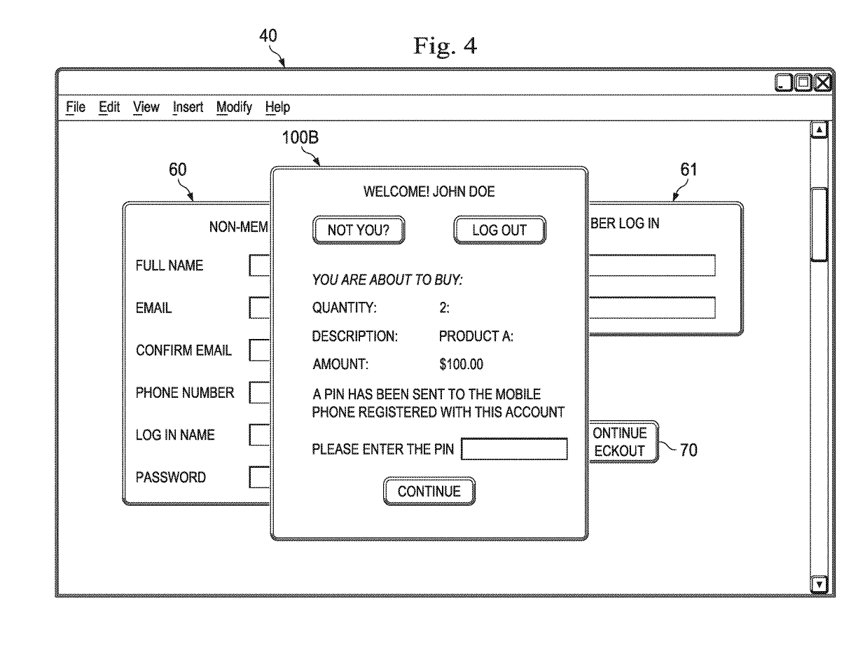

If the prospective buyer enters the correct login information, or if he is granted access after going through the account validation process described above, the third party payment platform will check its records to determine whether the prospective buyer has registered a communications device with his account. The communications device may be a personal mobile communications device, for example a mobile telephone, a pager, a Personal Digital Assistant (PDA) device, a tablet computer, or another suitable device. If no communication device has been registered (or linked with) the prospective buyer's account, the third party payment platform will redirect the prospective buyer to a different process flow, which will be discussed later in more detail. However, if it has been verified a communications device is linked with the account, then the third party payment platform directs its user interface to proceed to another screen 1009, which is illustrated in FIG. 4.

The screen 1009 may display the prospective buyer's name along with a welcome message. The screen 100B may also display information related to the prospective purchase, including quantity of the product to be purchased, description of the product to be purchased, total amount of the transaction, and other suitable information.

The screen 100B will also prompt the prospective buyer to enter a secret code. The secret code is generated by the third party payment platform in a dynamic and randomized manner. In other words, the secret code is not generated until the third party payment platform receives the authentication request from the merchant, and the secret code is different each time it is generated.

In an embodiment, the secret code is generated using Javascript or PHP integrated generation technology. As an example, if the secret code contains only numbers (a PIN), the following Javascript code may be used to generate the PIN:

var randomnumber=Math.floor(Math.random( )10)

where *10 dictates that a single digit will be randomly generated between 0-10. The above code may be repeated to generate each of the numbers of the multi-digit PIN. Alternatively, the PIN may be created as a single random number from 0-9999 by changing the variable in the code from *10 to *10000. The same algorithm can be used to generate PINs having other digit lengths.

As another example, if the secret code contains a plurality of alpha-numeric characters, the following Javascript code may be used as an example:

int x = 4;
char[ ] PIN = new char[x];
int c = ‘A’;
for(int p = 0; p < 4; p++)
{
int PIN = 0 + (int) (Math.random( )* 10);
switch(PIN)
{
case 0: c = ‘0’ + (int)(Math.random( ) * 10); break;
case 1: c = ‘A’ + (int)(Math.random( ) * 26); break; }
PIN[p] = (char)c; }
return new String(PIN);

The above code may be used to generate an alpha-numeric secret code by using randomly selected characters between 0-9 and a-z. It is understood that the above examples of the secret code's generation are merely examples and are not intended to be limiting, and that other suitable secret code generation techniques may be utilized in other embodiments.

The secret code here is different from “static codes” in that the secret code here does not remain the same for more than one transaction, even if the same prospective buyer is involved in all the transactions. Each transaction has its unique and randomly generated secret code. No “static code” is stored anywhere permanently, and as such, the secret code here cannot be easily stolen. Even if another person has illegally obtained access to the account with the third party payment system, such person cannot retrieve the secret code here, because the secret code is not permanently stored in any file linked with the account. In this manner, fraud risks of the transaction are reduced. The reduction of fraud risks will be discussed in more detail below.

In the embodiment shown in FIG. 4, the secret code is in the form of a personal identification number (PIN), which contains a plurality of integer digits, for example 4585, 34568, 839505, 275496, etc. The exact number of digits may vary from embodiment to embodiment. The secret code may also be alpha-numeric, meaning that the secret code can contain letters as well as digits. For example, the secret code may be Te84J5, 583jh6p0, dH34, 9If7e. The secret code may be case-sensitive or case-insensitive. In yet other embodiments, the secret code may also contain symbols, such as !, @, #, $, %, ̂, &, *, ( ), _, +, −, |, \, etc.

After the third party payment platform generates the secret code (a multi-digit PIN in this case), it sends the secret code to the communications device linked with the prospective buyer's account. For example, if the communications device is a mobile telephone, the prospective buyer may be informed via instruction shown on the screen 100B that a text message containing the secret code will be sent to the mobile telephone wirelessly. In other examples, the secret code may be sent to the mobile telephone in a Short Message Service (SMS), an email, or in an automated voice message.

It is understood that the text message, the SMS message, the email, or the automated voice message may also be sent to other forms of communications devices as well. For example, if the linked communications device is a landline telephone, au automated voice message containing the secret code may be sent to the landline telephone in a regular landline phone call. It is also understood that these listed methods of delivering the secret code are merely examples, and that alternative suitable methods of delivering the secret code may be employed if the delivery method is secure.

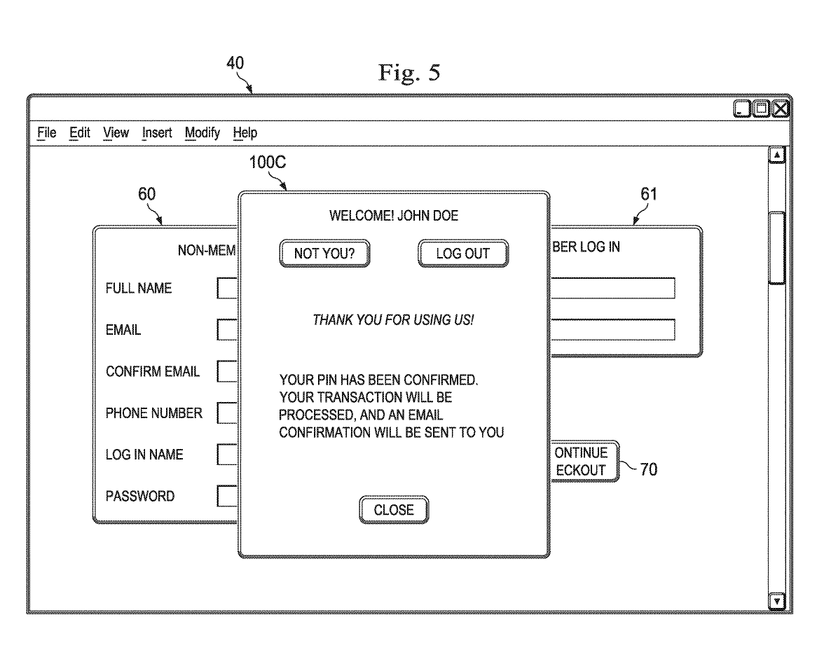

The purchasing transaction will continue if the prospective buyer has input the correct secret code. In the embodiment shown in FIG. 4, the prospective buyer inputs the secret code on the screen 100B of the user interface, for example through a computer keyboard. In other embodiments, the third party payment platform may let the user enter the secret code via the linked communications device, for example through a reply text message. In any case, if the correct secret code is entered, the third party payment platform may notify the merchant that the prospective buyer has been authenticated, and the prospective buyer may be directed to another screen 100C, shown in FIG. 5. The screen 100C indicates to the prospective buyer that his purchase has been completed, and a confirmation message may be sent to the prospective buyer.

However, if an incorrect secret code is entered, the third party payment platform may have several options. In one embodiment, the third party payment platform may supply a link to let the prospective buyer request the secret code be sent to the communications device again. In another embodiment, it may immediately discontinue the transaction and notify the merchant that the authentication of the prospective buyer has failed. In other embodiments, the third party payment platform may allow an incorrect secret code to be entered up to a predetermined number of times (e.g., 3 tries) before discontinuing the transaction and notifying the merchant.

In yet another embodiment, even if the number of incorrect entries of the secret code has exceeded the predetermined number of times, the third party payment platform may still allow the transaction to continue. However, the third party payment platform will apply a higher level fraud model to the transaction. The higher level fraud model may review the transaction based on a number of factors, including but not limited to, the total amount of the transaction, the frequency of recent (e.g., the past few hours, days, weeks, or months) transactions, the type of goods the prospective transaction involves and whether it is consistent with the prospective buyer's purchasing history, the location of the prospective buyer's login and whether that is consistent with the prospective buyer's normal location, etc.

In an embodiment, the higher level fraud model may utilize sophisticated. mathematical algorithms based at least in part on the above factors to calculate an “authentication score” (also referred to as “reliability score”) for the transaction, and if the authentication score fails to meet a predetermined threshold, the transaction may then be discontinued. In another embodiment, the third party payment platform may also use live and experienced human agents to evaluate whether the transaction should be processed, based at least in part on the above factors. In other embodiments, a combination of computer algorithms and live personnel may also be used in making the final decision.

In addition to (or in combination with) applying the higher level fraud model to the transaction if the prospective buyer has failed to supply the correct secret code, the third party payment platform may also direct the prospective buyer to the account validation process discussed above. Namely, the prospective buyer will have to answer one or more secret questions whose answers are not computer-accessible even to the account owner. Instead, the account owner has to know these answers by heart. This means that a hacker cannot get past the account validation flow even if he has otherwise illegally gained access to the prospective buyer's account with the third party payment platform. For the sake of simplicity, the account validation process flow is not illustrated herein.

One of the reasons why the secret code is randomly and dynamically generated and delivered to the prospective buyer's registered communications device is to help verify the prospective buyer's identity and to reduce risks of fraud. As discussed above, current online market transactions are vulnerable to various forms of fraud, including identity theft. It is possible to envision a scenario where a hacker has hacked into a victim's account with the third party payment platform. The hacker may attempt to purchase goods from the merchant's website and ask the merchant to send the goods to the hacker's address, meanwhile attempting to use the victim's account with the third party payment platform to pay for the transaction.

It may be difficult for conventional online transaction systems to identify and prevent such a fraud scheme described above. However, this type of fraud scheme will not work with systems utilizing the various embodiments of the present disclosure. In the same scenario with the hacker discussed above, even if the hacker has gained access to the victim's account with the third party payment platform, it is unlikely for such hacker to also have physical possession or access to the victim's registered communications device. Thus, when the hacker attempts to complete the purchasing transaction, he will be unable to do so, because he cannot enter the correct secret code. Hence, the hacker's fraudulent purchases may be thwarted. In addition, in response to one or more failed entries of the secret code, the third party payment platform may also automatically suspend the prospective buyer's account and/or notify the buyer that suspicious activity is taking place with the account. In this manner, the victim may quickly discover that his identity has been compromised, and he may take actions necessary to address this issue before the hacker can engage in further fraudulent transactions.

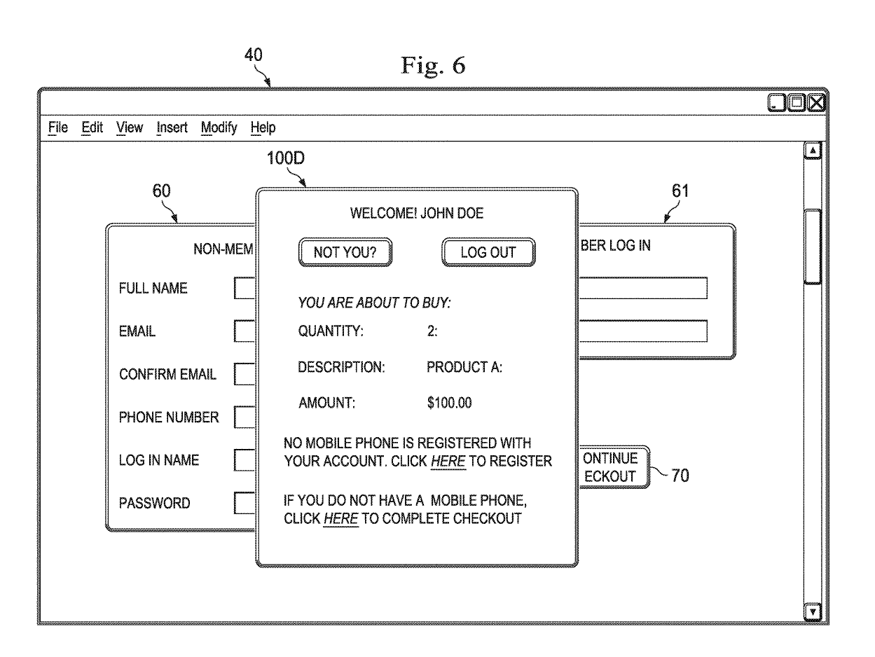

The above discussions describe a process flow applied if the prospective buyer's account with the third party payment platform is linked with a communications device. If the prospective buyer's account with the third party payment platform is not linked with a communications device, an alternative process flow is used. The first few steps of this alternative process flow are the same as the process flow described above. Namely, the prospective buyer goes on the merchant's website and chooses which products to buy (FIG. 1), registers with the merchant's website as a new member or logs in to the website as a returning member during checkout (FIG. 2), and chooses which third party payment platform to use to complete the transaction and logs in to the third party payment platform (FIG. 3). As discussed above, the third party payment platform will check to see whether the prospective buyer has a communications device linked with the account. If not, then instead of displaying the screen 100B shown in FIG. 4 to the prospective buyer, the third party payment platform displays a screen 100D, shown in FIG. 6.

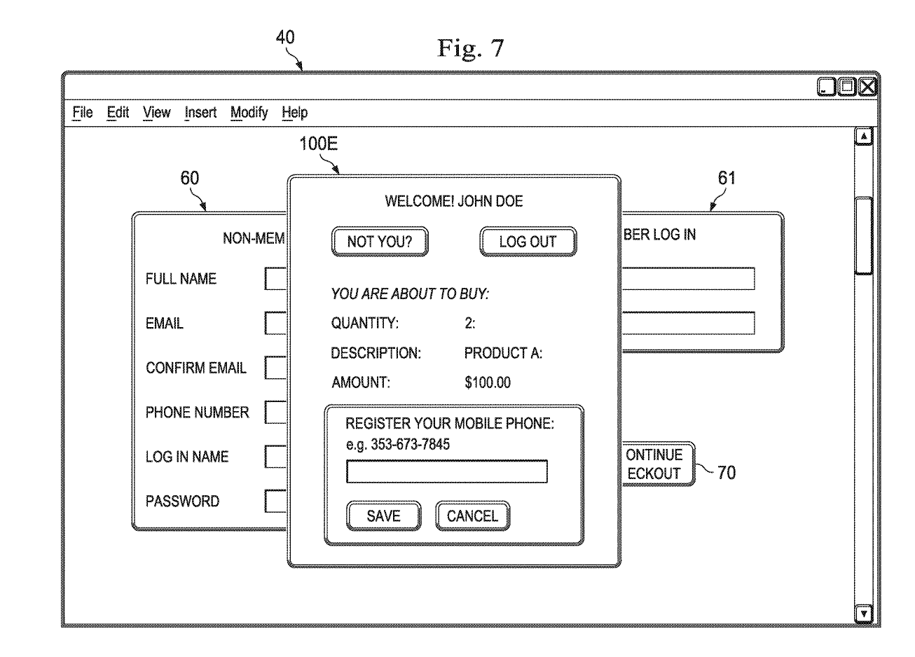

Referring to FIG. 6, the screen 100D is similar to the screen 100B in that it displays a welcome message along with the information related to the purchasing transaction. However, instead of prompting the prospective buyer to enter the secret code (e.g., PIN), the screen 100D notifies the prospective buyer that no mobile phone (or other types of communications device) is registered with the account, and provides a link for the registration of the mobile phone. The screen 100D also provides a link for letting the prospective buyer check out without registering the mobile phone. However, if the prospective buyer chooses this course of action, then the higher level fraud model discussed above and/or the account validation process (after too many incorrect secret code entries) may be invoked to ensure that fraud risks are minimized. If the prospective buyer chooses to register his communications device, the third party payment user interface proceeds to screen 100E, which is displayed in FIG. 7. Referring to FIG. 7, the screen 100E provides a field for the prospective buyer to register his mobile phone number. In an embodiment, the third party payment platform will not accept mobile phone numbers associated with prepaid phones, due at least in part to the higher level fraud risks associated with prepaid phones. The payment platform may require additional authentication from the buyer added security. For example, the payment provider may perform more extensive authentication, such as based on location or asking the buyer to provider more information related to the account. This may help prevent a fraudster from linking the fraudster's device to the legitimate buyer's account.

After the prospective buyer enters the mobile phone number and clicks the “save” button, the third party payment platform will generate a secret code in the random and dynamic manner discussed above and will thereafter send the secret code to the newly registered mobile phone. The third party payment platform also displays the screen 100B shown in FIG. 4 to the prospective buyer and prompts him to enter the secret code. The remaining steps of the process flow are similar to those discussed above in association with FIGS. 4 and 5.

In both of the process flows described above, the secret code is generated randomly and dynamically rather than being a static code that is stored somewhere in the user's account. As such, the secret code is unique to each individual transaction, which reduces the risk of a breached secret code being used for multiple fraudulent transactions. In an embodiment, the secret code will be visible to the prospective buyer but not to the merchant.

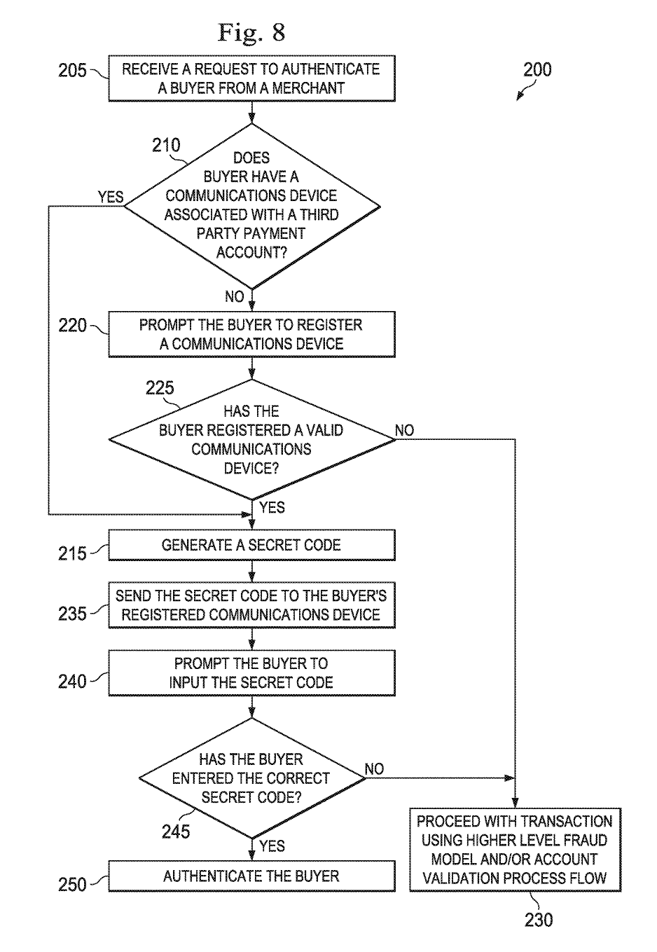

FIG. 8 is a flowchart of a method 200 that illustrates the process flow discussed above according to various aspects of the present disclosure. The method 200 includes block 205, in which an authentication request is received from a merchant. The merchant generates the request when a prospective buyer chooses goods to buy from the merchant and initiates a checkout process. In order to verify the prospective buyer's identity, the merchant sends the request to a third party payment platform of the prospective buyer's choice. The third party payment platform receives the authentication request and proceeds with the remaining steps of the authentication process.

The method continues with a decision block 210, in which the third party payment platform determines whether the buyer has a communication device registered/linked with the buyer's account of the third party payment platform. If the answer returned by the decision block 225 is yes, then the method proceeds to block 215, in which the third party payment platform generates a secret code in a random and dynamic manner. In an embodiment, the secret code is a multi-digit PIN. If the buyer does not have a linked communication device, then the method 200 proceeds to block 220, in which the third party payment platform prompts the buyer to register a valid communications device. The communications device is a mobile telephone in one embodiment, but may include other suitable personal communication devices in alternative embodiments, such as pagers, PDA devices, tablets, laptops, landline telephones, etc. In an embodiment, a valid communications device cannot include a prepaid mobile phone.

After the buyer is prompted to register the communications device in block 220, the method 220 proceeds to a decision block 225, in which the third party payment platform determines whether the buyer has registered a valid communications device. The third party payment platform may check its records associated with the buyer's account to verify whether the buyer has previously linked a valid communications device to the buyer's account. If the answer is yes, then the method 200 proceeds to block 215 in which the secret code is generated. If the answer returned by the decision block 225 is no, then the method 200 proceeds to block 230, where a higher level fraud model and/or the account validation process flow discussed above is applied to the transaction. The higher level fraud model may involve sophisticated mathematical calculations and/or a human agent to evaluate the fraud risk level of the pending transaction. The account validation process flow may require the prospective buyer to correctly answer secret questions where the answers are known to him but not stored in his account.

The method 200 then proceeds to block 235, in which the third party payment platform delivers the secret code to the buyer's registered communications device. The delivery of the secret code may be done through a cellular network, a landline network, a fiber optics network, a GPS satellite, or through any other suitable remote transmission techniques. The method 200 also proceeds to block 240 in which the buyer is prompted to input the secret code in order to verify his identity.

After the buyer enters the secret code, the method 200 proceeds to a decision block 245 to determine if the buyer has entered the correct secret code. The buyer may be given a predetermined number of attempts (e.g., 3 attempts or less). If the correct secret code is entered within the predetermined number of attempts, the method 200 proceeds to block 250 in which the buyer is authenticated, meaning his identity is confirmed and that the purchasing transaction may proceed. Thereafter, the third party payment platform may transfer the necessary funds to the merchant in accordance with the terms of the transaction. If the correct secret code has not been entered within the number of predetermined attempts, then the method 200 proceeds to block 230 in which the higher level fraud model and/or the account validation process flow is applied, as discussed above. In another embodiment, the transaction may be denied, without processing in block 230, if the buyer has not entered the correct secret code within the maximum number of tries.

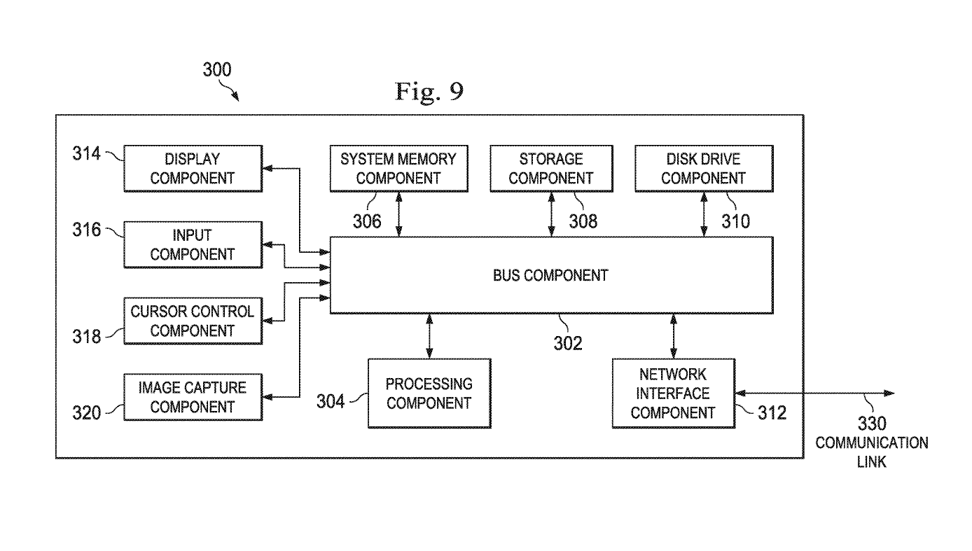

FIG. 9 is a block diagram of a computer system 300 suitable for implementing various methods and devices described herein, for example, the various method blocks of the method 200. In various implementations, user devices (such as managed by the prospective buyer) may comprise a network communications device (e.g., mobile cellular phone, laptop, personal computer, etc.) capable of communicating with a network, and a service provider device (such as managed by a third party payment platform) may comprise a network computing device (e.g., a network server). In other implementations, it should be appreciated that the service provider device may comprise a network communications device (e.g., mobile cellular phone, laptop, personal computer, etc.) capable of communicating with the network, without departing from the scope of the present disclosure. Accordingly, it should be appreciated that each of the devices may be implemented as the computer system 300 for communication with the network in a manner as follows.

In accordance with various embodiments of the present disclosure, the computer system 300, such as a mobile communications device and/or a network server, includes a bus component 302 or other communication mechanisms for communicating information, which interconnects subsystems and components, such as processing component 304 (e.g., processor, micro-controller, digital signal processor (DSP), etc.), system memory component 306 (e.g., RAM), static storage component 308 (e.g., ROM), disk drive component 310 (e.g., magnetic or optical), network interface component 312 (e.g., modem or Ethernet card), display component 314 (e.g., cathode ray tube (CRT) or liquid crystal display (LCD)), input component 316 (e.g., keyboard), cursor control component 318 (e.g., mouse or trackball), and image capture component 320 (e.g., analog or digital camera). In one implementation, disk drive component 310 may comprise a database having one or more disk drive components.

In accordance with embodiments of the present disclosure, computer system 300 performs specific operations by processor 304 executing one or more sequences of one or more instructions contained in system memory component 306. Such instructions may be read into system memory component 306 from another computer readable medium, such as static storage component 308 or disk drive component 310. In other embodiments, hard-wired circuitry may be used in place of (or in combination with) software instructions to implement the present disclosure.

Logic may be encoded in a computer readable medium, which may refer to any medium that participates in providing instructions to processor 304 for execution. Such a medium may take many forms, including but not limited to, non-volatile media and volatile media. In one embodiment, the computer readable medium is non-transitory. In various implementations, non-volatile media includes optical or magnetic disks, such as disk drive component 310, and volatile media includes dynamic memory, such as system memory component 306. In one aspect, data and information related to execution instructions may be transmitted to computer system 300 via a transmission media, such as in the form of acoustic or light waves, including those generated during radio wave and infrared data communications. In various implementations, transmission media may include coaxial cables, copper wire, and fiber optics, including wires that comprise bus 302.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 330 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 300 may transmit and receive messages, data, information and instructions, including one or more programs (i.e., application code) through communication link 330 and communication interface 312. Received program code may be executed by processor 304 as received and/or stored in disk drive component 310 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be appreciated that like reference numerals are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
receiving a request to authenticate a consumer who initiated a prospective transaction using a first communications device;
determining whether the consumer has a second communications device linked to an account of the consumer with a third party payment provider, wherein the second communications device is separate and different from the first communications device;
generating, in response to the determining, a random and non-static secret code that changes each time it is generated;
sending the secret code to the second communications device;
prompting the consumer to input the secret code via a pop-up window that is overlying a checkout webpage that is displayed on the first communications device;
detecting an input in the pop-up window from the consumer in response to the prompting; and
selectively authenticating the consumer based on the detected input from the consumer;
wherein the receiving, the determining, the generating, the sending, the prompting, the detecting, and the selectively authenticating are performed by one or more electronic processors.

2. The method of claim 1, wherein the generating the secret code comprises generating the secret code only after the request to authenticate the consumer is received.

3. The method of claim 1, wherein the generating the secret code comprises generating the secret code using Javascript.

4. The method of claim 1, further comprising: preventing a permanent storage of the secret code.

5. The method of claim 1, further comprising: generating the pop-up window using a Javascript lightbox.

6. The method of claim 1, wherein a different secret code is generated for each different prospective transaction.

7. The method of claim 1, wherein the selectively authenticating comprises:
retrieving, in response to a determination that the detected input fails to match the secret code, a location of the consumer at a time when the request is received;
calculating a reliability score of the transaction based on the location of the consumer; and
granting the request in response to the reliability score meeting a predetermined threshold.

8. The method of claim 1, wherein the selectively authenticating comprises:
determining, in response to a determination that the detected input fails to match the secret code, a frequency of recent transaction associated with the consumer;
calculating a reliability score of the transaction based on the frequency of the recent transactions; and
granting the request in response to the reliability score meeting a predetermined threshold.

9. The method of claim 1, wherein the selectively authenticating comprises:
determining, in response to a determination that the detected input fails to match the secret code, a total amount of the prospective transaction;
calculating a reliability score of the transaction based on the total amount of the prospective transaction; and
granting the request in response to the reliability score meeting a predetermined threshold.

10. The method of claim 1, wherein the selectively authenticating comprises:
determining, in response to a determination that the detected input fails to match the secret code, a type of goods involved in the prospective transaction;
calculating a reliability score of the transaction based on the type of goods involved in the prospective transaction; and
granting the request in response to the reliability score meeting a predetermined threshold.

11. A system, comprising:
a non-transitory memory; and
one or more hardware processors coupled to the non-transitory memory and configured to read instructions from the non-transitory memory to cause the system to perform operations comprising:
receiving from an online merchant, a request to authenticate a consumer who selected, at a checkout webpage of the online merchant displayed on a first communications device, a third party payment provider as a payment option to pay for a prospective transaction between the consumer and the online merchant;
determining whether the consumer has an account with the third party payment provider as well as a second communications device associated with the account, wherein the second communications device is separate and different from the first communications device;
generating, in response to the determining and after the request to authenticate the consumer is received, a random and dynamic secret code;
sending the secret code to the second communications device, wherein the secret code is not stored in the second communications device;
prompting the consumer to input the secret code via a pop-up window that is overlying the checkout webpage that is displayed on the first communications device;
detecting an input in the pop-up window from the consumer in response to the prompting; and
selectively authenticating the consumer based on the detected input from the consumer.

12. The system of claim 11, wherein the generating the secret code comprises generating the secret code using Javascript.

13. The system of claim 11, further the operations further comprise: generating the pop-up window using a Javascript lightbox.

14. The system of claim 11, wherein a different secret code is generated for each different prospective transaction and changes each time it is generated.

15. The system of claim 11, wherein the selectively authenticating comprises:
retrieving, in response to a determination that the detected input fails to match the secret code, a location of the consumer at a time when the request is received;
calculating a reliability score of the transaction based on the location of the consumer; and
granting the request in response to the reliability score meeting a predetermined threshold.

16. The system of claim 11, wherein the selectively authenticating comprises:
determining, in response to a determination that the detected input fails to match the secret code, a frequency of recent transaction associated with the consumer;
calculating a reliability score of the transaction based on the frequency of the recent transactions; and
granting the request in response to the reliability score meeting a predetermined threshold.

17. The system of claim 11, wherein the selectively authenticating comprises:
determining, in response to a determination that the detected input fails to match the secret code, a total amount of the prospective transaction;
calculating a reliability score of the transaction based on the total amount of the prospective transaction; and
granting the request in response to the reliability score meeting a predetermined threshold.

18. The system of claim 11, wherein the selectively authenticating comprises:
determining, in response to a determination that the detected input fails to match the secret code, a type of goods involved in the prospective transaction;
calculating a reliability score of the transaction based on the type of goods involved in the prospective transaction; and
granting the request in response to the reliability score meeting a predetermined threshold.

19. A non-transitory machine-readable medium having stored thereon machine-readable instructions executable to cause a machine to perform operations comprising:
receiving from an online merchant, a request to authenticate an entity who selected, at a checkout webpage of the online merchant displayed on a first communications device, a third party payment provider as a payment option to pay for a prospective transaction between the entity and the online merchant;
determining whether the entity has an account with the third party payment provider as well as a second communications device associated with the account, wherein the second communications device is separate and different from the first communications device;
generating, in response to the determining and after the request to authenticate the entity is received, a random and non-static secret code using Javascript, wherein the secret code changes each time it is generated, is not permanently stored, and is unique for each different prospective transaction;
electronically transmitting the secret code to the second communications device;
generating a pop-up window that is superimposed over the checkout webpage displayed on the first communications device;
prompting the entity to input the secret code via the pop-up window;
detecting an input in the pop-up window from the entity in response to the prompting; and
selectively authenticating the entity based on the detected input from the entity.

20. The non-transitory machine-readable medium of claim 19, wherein the selectively authenticating comprises:
determining, in response to a determination that the detected input fails to match the secret code, information selected from the group consisting of: a location of the entity at a time when the request is received, a frequency of recent transaction associated with the consumer, a total amount of the prospective transaction, and a type of goods involved in the prospective transaction;
calculating a reliability score of the transaction based on the location of the consumer; and
granting the request in response to the reliability score meeting a predetermined threshold.
